(19) United States
(12) Patent Application Publication
(10) Pub. No.: US 2008/0031484 A1
(43) Pub. Date: Feb. 7, 2008

(54) Ear Headphone Unit And A Computer System

(76) Inventor: Niklas Danielson, Sollentuna (SE)

Correspondence Address: Richard R Michaud;Michaud-Duffy Group, 306 Industrial Park Road, Suite 206, Middletown, CT, 06457-1532, US

(21) Appl. No.: 11/632,032

(22) PCT Filed: Jun. 21, 2005
(86) PCT No.: PCT/SE05/00981

§ 371 Date: Jan. 8, 2007

(30) Foreign Application Priority Data
Jul. 12, 2004 (SE) 0401845-3

(51) Int. Cl. H04R 25/00

(52) U.S. Cl. 381/375; 381/370

(57) ABSTRACT

The invention concerns a unit (10) comprising a headset (11) having a curved flexible support member (50) for holding the headset (11) onto a user's head. The support member (50) has a first (61) and a second (62) end portion which can be moved away from each other. The headset (11) has an ear-headphone part (14). The unit (10) has a switching member (20) with at least a first and a second switching state. In the first switching state, the unit (10) is connected for use such that said ear-headphone part (14) is active. The headset (11) has switching activating means (54) which are such that said first switching state is initiated by moving said first (61) and second (62) end portions away from each other. The invention also concerns a computer system comprising a unit (10) according to the above.

### BACKGROUND OF THE INVENTION AND PRIOR ART

The invention concerns an ear-headphone unit comprising a headset having a curved flexible support member which is configured to be able to extend around a part of a user's head in order to hold the headset onto said head. The support member comprises a first and a second end portion which can be moved in a direction away from each other before the headset is attached to the head of the user. The headset comprises an ear-headphone part which is arranged on the headset such that when the headset is attached as intended to a user's head, the ear-headphone part is arranged at at least one ear of the user. The unit is arranged to be able to be connected to a computer such that sounds can be produced by said ear-headphone part with the help of the computer. The computer is of the kind which at least also can be connected to a loudspeaker, which can be a desk or floor loudspeaker, or which has a built-in loudspeaker.

Such a unit and computer are already known. The unit thus comprises a headset which can be used together with a computer. The headset can include only one ear-headphone, for one ear of a user or two ear-headphones: one for each ear of a user. It is also known that such a headset can also include a microphone arranged near the user's mouth, when the headset is arranged as intended on a user's head. The support member can for example constitute a curved support with two end portions: a first ear-headphone can be attached at the first end portion and a second ear-headphone can be attached at the second end portion. The curved support member thus extends above the head when the headset is positioned on the head of a user. The support member is normally flexible such that the ear-headphones can be flexed apart before the headset is positioned on the head of a user. The headset may thus be kept in position on the head with the help of a small spring action caused by the flexible support member.

With the unit, communication can take place with the computer. The communication can take place only with the computer, for example in that commands are fed into the computer via the microphone part and in that sounds produced with the help of computer programs are heard via the ear-headphones. However, it is more and more common that the computer is used as an alternative to an ordinary telephone. It is thus possible to via the computer carry on a conversation with a person who is located at another computer. This communication takes most often place via the Internet. It should also be noted that a computer, for example a personal computer, normally has connected loudspeakers, which usually are separate and positioned on a desk or on the floor. The loudspeakers are usually connected via the loudspeaker input terminal of the computer. A computer often also has a separate microphone which is connected with the help of a cable to the microphone input terminal of the computer. Sometimes the loudspeakers and/or the microphone are built-in in the computer, for example near the viewing screen. When the computer is used for conversational communication with another person, such a separate microphone and separate loudspeakers (or built-in microphone and loudspeakers of the computer) can of course be used. However, conversational communication via the regular microphone and loudspeakers of the computer does often not work very well. A user therefore often finds that it is more comfortable to talk with the help of an ordinary telephone where a telephone handset is held against the ear or where a headset is arranged on the head.

Furthermore, more and more people nowadays use the computer in an open-plan office or in a room where other people are present. It can therefore be considered disturbing that conversational communication takes place via the loudspeakers, since the sound thereby also reaches the people who are near. If, furthermore, the conversation is confidential, it is of course a significant disadvantage that it takes place via loudspeakers that several persons can hear.

Also when a headset is used only for communication with the computer (i.e. no conversation with another person), the user normally has to disconnect the ordinary desk or floor loud speakers of the computer (and a possible separate microphone of the computer) and instead connect the headset to the computer. Such a connection and disconnection is often found inconvenient. When the user has stopped using the headset, the normal external loudspeakers of the computer (and a possible separate microphone) has to be connected again to the computer.

### SUMMARY OF THE INVENTION

An object of the present invention is to provide a unit with which the above-described problems are avoided. A further object is to provide such a unit which can been used in addition to for example the ordinary external loudspeakers of the computer Still an object is to provide such a unit which thereby in a simple manner is activated and deactivated at the same time as such external loudspeakers are deactivated and activated, respectively.

These objects are achieved by a unit of the kind that is described in the first paragraph above and which is characterised in that said unit comprises a switching member with at least a first and a second switching state, wherein the unit is arranged such that, when the unit is connected as intended to said computer and the switching member is in said first switching state, the unit is connected for use such that said ear-headphone part is active while said desk or floor loudspeaker or built-in loudspeaker is not active, wherein in said second switching state at least said ear-headphone part is not active while said desk or floor loudspeaker or built-in loudspeaker is active and wherein said headset comprises switching activating means which are such that said first switching state is initiated by moving said first and second end portions away from each other.

It can be noted that the second switching state may for example be initiated when the first and second end portions are moved towards each other. Alternatively, it is possible that also the second switching state is initiated by moving the first and second end portions away from each other. In this case, the first switching state can for example be initiated every second time the first and second end portions are moved away from each other and also the second switching state can thereby be initiated every second time the first and second end portions are moved away from each other.

It should also be noted that when in this document it is said that a loudspeaker or a microphone (or an ear-headphone part or microphone part) is “active”, it is meant that this loudspeaker or microphone etc. is connected such that sound can be produced by the loudspeaker and such that sound can be transferred via the microphone. When it is said that a loudspeaker or a microphone etc. is not active, it is thus meant that these entities cannot be actively used in order to reproduce or to enter sound.

It should also be noted that the ear-headphone part can be intended for one ear or for both ears (i.e. it can include one or two ear-speakers). If for example stereo sound is to be produced, the ear-headphone part conveniently consists of two sound reproducers that are to be arranged at the ears of a user. Also the microphone part can be a mono or stereo microphone.

With the unit according to the invention, switching can thus in a simple manner take place between said first and second switching states. For example, a person who works at the computer can normally use the built-in or external loudspeakers of the computer. The switching member is thus in said second switching state. When the person in question wants to use the headset, the switching member is switched to the first switching state simply by moving said first and second end portions away from each other. This is normally done automatically, for example when the person picks-up the headset from for example the desk and positions the headset onto the head.

According to an embodiment of the invention, said support member comprises a first part, which includes said first end portion, and a second part, which includes said second end portion, wherein said first and second parts are pivotally connected to each other in a connection area, wherein said switching activating means is located in said connection area and arranged such that when the first and second end portions are moved away from each other, a relative pivotal movement takes place between said first and second parts, wherein said relative pivotal movement causes the switching activating means to initiate said first switching state. This embodiment constitutes a relatively simple and reliable manner of implementing the switching activation.

According to a further embodiment of the invention, the unit comprises a transmitter member arranged such that the unit can communicate in a wireless manner with said computer, wherein the transmitter member is arranged such that when said switching member is in or is being switched to said first switching state, the transmitter member transmits a control signal to a corresponding receiver member connected to the computer, such that the control signal ensures that when the switching member is in the first switching state, the computer is arranged such that the unit is connected for use together with the computer while said desk or floor loudspeaker or built-in loudspeaker is not active. According to this embodiment, the unit communicates with the computer in a wireless manner.

According to another embodiment of the invention, the unit comprises a cable which on one hand is connected to or arranged to be connected to at least said ear-headphone part and on the other hand is arranged to be connected at least to said computer. With the help of such a cable, a safe connection can be established between the unit and the computer.

The cable can be provided with at least a first contact member and a second contact member, wherein the first contact member is arranged to be connected to the computer and the second contact member is arranged to, for example via a further cable, be connected to said desk or floor loudspeaker. The unit can in this way in a simple manner be connected between the computer and the desk or floor loudspeaker of the computer.

The first contact member can be a male contact of standard type which is configured to be plugged into a corresponding female contact which constitutes the loudspeaker input terminal of the computer, wherein said second contact member can be a female contact of standard type which is configured to receive a corresponding male contact on a cable from said desk or floor loudspeaker. Since the contacts are of standard type, no modification needs to be done of the computer or of the external loudspeakers of the computer. Instead, the whole cable from the unit can simply be connected between the computer and such external loudspeakers.

According to a further embodiment, the headset also comprises a microphone part which is arranged on the headset such that when the headset is attached as intended to a user's head, the microphone part is arranged near the user's mouth.

According to still an embodiment, the unit is arranged such that when the unit is connected as intended to said computer and the switching member is in said first switching state, said microphone part is active while a possible built-in microphone of the computer or a separate microphone, with which the computer is connected, is not active, wherein when the switching member is in said second switching state, said microphone part is not active while said possible built-in microphone of the computer or said separate microphone, with which the computer is connected, is active. This embodiment is thus particularly advantageous if the computer also has another microphone connected to or built-in in the computer. The microphone part in the unit according to the invention thus takes over the microphone function when the switching member is in the first switching state.

According to an embodiment, said cable is also connected to or arranged to be connected to said microphone part. The cable can be provided also with a third contact member and a fourth contact member, wherein the third contact member is arranged to be connected to the computer and the fourth contact member is arranged to, for example via a further cable, be connected to said separate microphone. The third contact member can be a male contact of standard type which is configured to be plugged into a corresponding female contact which constitutes the microphone input terminal of the computer and the fourth contact member can be a female contact of standard type which is configured to receive a corresponding male contact on a cable from said separate microphone. The unit can hereby in a simple manner be connected also between the computer and the separate microphone. Furthermore, similarly to what has been explained above, since the contacts are of standard type, no modification needs to be done of the computer or of the external microphone of the computer. Instead, the whole cable from the unit can simply be connected between the computer and such an external microphone.

According to an embodiment, the unit is arranged to be able to be connected to said computer in order to with the help of the unit enable conversational communication via a network for computers, for example the Internet, wherein the unit is arranged such that, when the unit is connected as intended to said computer and the switching member is in said first switching state, the unit is connected for use for conversational communication via the computer such that said microphone part and said ear-headphone part are active while said desk or floor loudspeaker or built-in loudspeaker is not active, wherein in said second switching state at least said ear-headphone part is not active while said desk or floor loudspeaker or built-in loudspeaker is active. A user may thus in a comfortable manner use the unit for conversational communication. When the conversation is over, switching can in a simple manner take place to the second switching state such that the user can continue to work with the computer with the loudspeakers of the computer being active.

The purpose of he invention is also achieved by a computer system comprising a unit according to any of the preceding embodiments and said computer with at least one loudspeaker which can be a desk or floor loudspeaker or which can be built-in in the computer. The computer, the loudspeaker of the computer and the unit thus form part of the system. Possibly also a separate computer microphone can form part of the computer system. With such a system, the above-described advantages are achieved.

### SHORT DESCRIPTION OF THE DRAWINGS

The present invention will now be explained with the help of embodiment alternatives given as examples and with reference to the attached drawings.

FIG. 1 shows schematically a computer with peripheral equipment according to the prior art.

FIG. 2 shows schematically an embodiment of the unit according to the invention.

FIG. 3 shows schematically an alternative embodiment of the unit according to the invention.

FIG. 4 shows schematically a circuit diagram where the switching member which forms part of the unit according to the invention is in a first switching state.

FIG. 5 shows schematically a circuit diagram where the switching member which forms part of the unit according to the invention is in a second switching state.

FIGS. 6-9 show schematically different embodiments of a headset that forms part of a unit according to the invention.

### DESCRIPTION OF EMBODIMENTS OF THE INVENTION

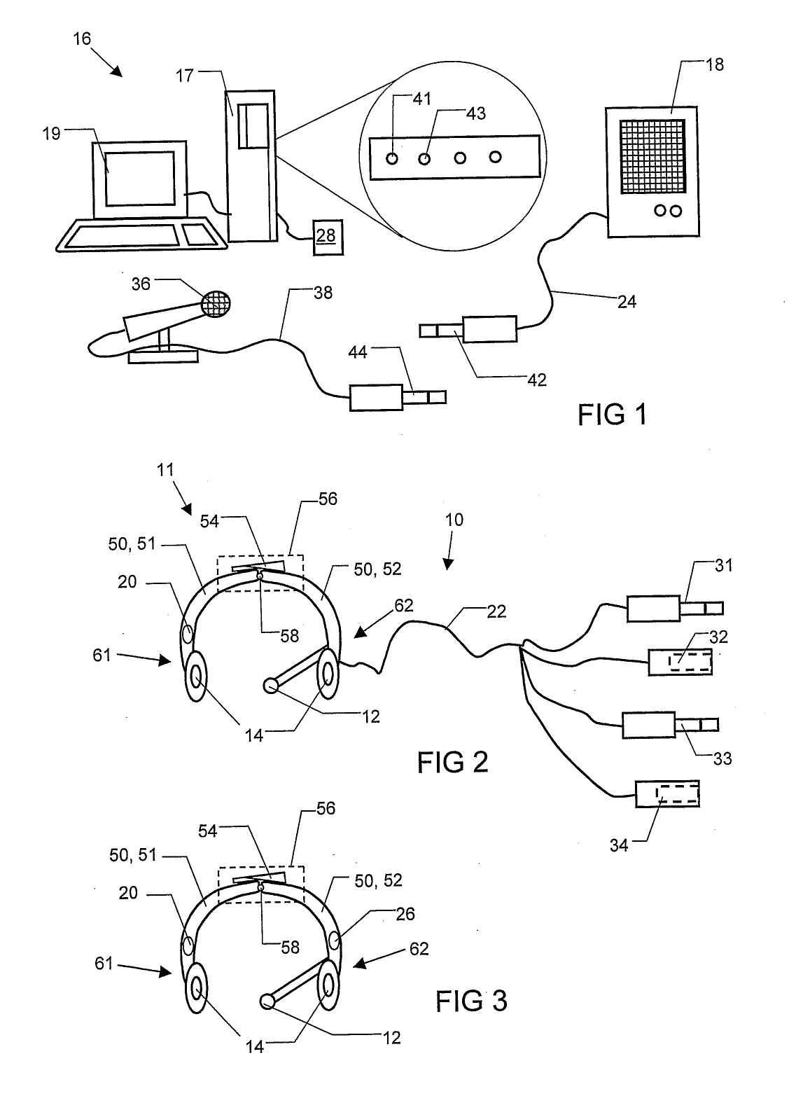

FIG. 1 shows schematically a computer 16 with peripheral equipment. The computer 16 comprises according to this embodiment the actual computer part 17 and a viewing screen 19. The computer 16 can also be connected to a transmitter/receiver unit 28 which enables a wireless communication with the peripheral equipment. However, usually the communication with the peripheral equipment takes place via cables. Within the circle in FIG. 1 an example of input terminals to the computer 16 is schematically shown. These input terminals are often positioned on the back of the computer unit 17. The input terminals are usually of a standard format. An input terminal 41 can for example be a female contact which constitutes the loudspeaker input terminal of the computer 16. Another input terminal 43 can for example be a female contact which constitutes the microphone input terminal of the computer 16. The computer 16 is usually connected to different peripheral equipment. FIG. 1 shows schematically a loudspeaker 18 which for example can be a desk or floor loudspeaker. From the loudspeaker 18 a cable 24 extends. At the end of the cable 24 there is a male contact 42 of standard format which is configured to be plugged into a corresponding female contact 41 of the computer 16. FIG. 1 also schematically shows a separate microphone 36 which can be connected to the computer 16. From the microphone 36 a cable 38 extends. At the end of the cable 38 a male contact 44 is arranged. This male contact is suitably of a standard format and configured to be plugged into a corresponding female contact 43 of the computer 16.

It should be noted that it is also conceivable that the computer 16 instead has built-in loudspeakers and/or a built-in microphone.

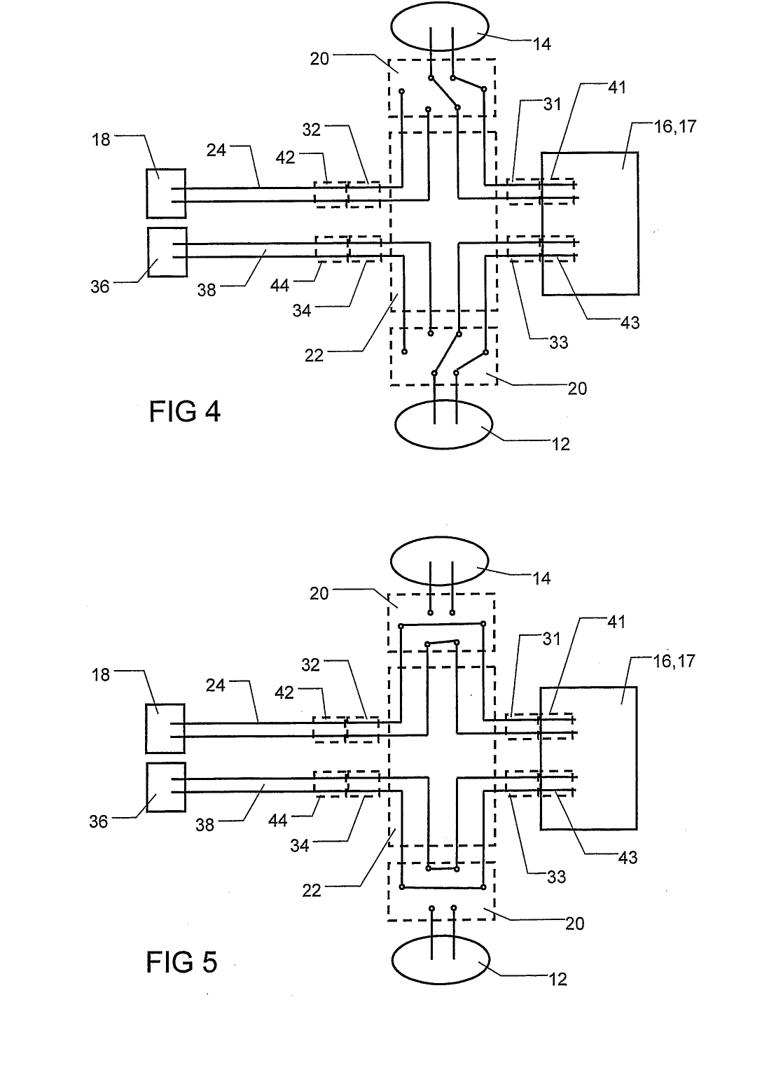

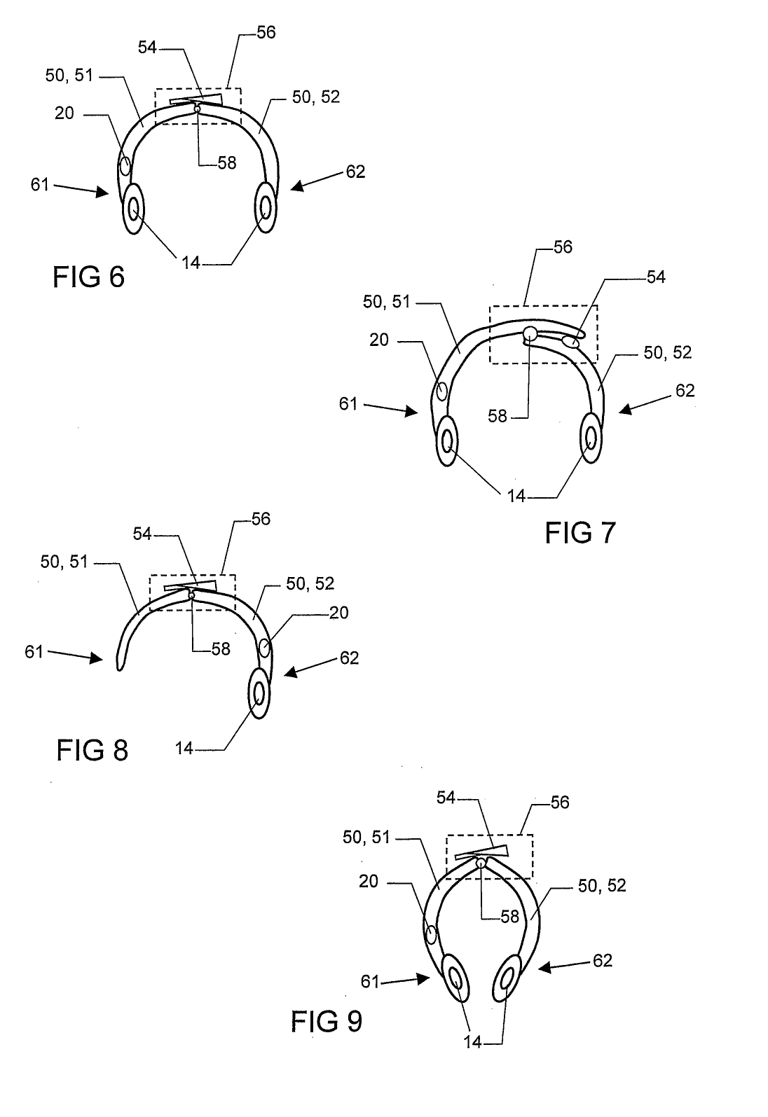

FIG. 2 schematically shows an embodiment of an ear-headphone unit 10 according to the invention. In FIG. 2 the whole unit is referred to with the reference number 10 and a headset that is comprised in the unit 10 has the reference number 11. The unit 10 thus includes a headset 11 with a microphone part 12 and an ear-headphone part 14. These parts are arranged on the headset 11 such that when the unit 10 is used as intended, the ear-headphone part 14 is arranged at or is held against the ear of a user while the microphone part 12 is arranged near the user's mouth. The unit 10 can be connected to a computer 16, for example in order to enable conversational communication via the computer 16. The unit 10 has a switching member 20 which has at least a first and a second switching state. When the unit 10 is connected to the computer 16, the unit 10 is connected for use via the computer when the switching member 20 is in the first switching state. In the first switching state, the microphone part 12 and the ear-headphone part 14 are active while a desk or floor loudspeaker 18 or a built-in loudspeaker in the computer 16 is not active. However, in the second switching state, the desk or floor loudspeaker 18 or a built-in loudspeaker in the computer 16 is active while the ear-headphone part 14 is not active. The switching states will be described more closely in connection with FIG. 4 and FIG. 5 and the headset 11 will be described more closely in connection with FIG. 6-9.

The unit 10 has a cable 22 which contains wires which are connected to the microphone part 12 and the ear-headphone part 14. At the other end of the cable 22 there is a first contact member 31, a second contact member 32, a third contact member 33 and a fourth contact member 34. The first contact member 31 is a male contact of standard type and is configured to be plugged into the female contact 41 which constitutes the loudspeaker input terminal of the computer 16. The second contact member 32 is a female contact of standard type which is configured to receive a male contact 42 on the cable 24 from the loudspeaker 18. The third contact member 33 is a male contact of standard type which is configured to be plugged into the female contact 43 which constitutes the microphone input terminal of the computer 16. The fourth contact member 34 is a female contact of standard type which is configured to receive the male contact 44 on the cable 38 from the separate microphone 36. In this manner, the unit 10 can be connected to the computer 16 and to the loudspeaker 18 and the microphone 36.

FIG. 3 shows schematically an alternative embodiment of the unit 10. In this case the unit 10 has a transmitter member 26. The transmitter member 26 can suitably also comprise a receiver member. The transmitter member 26 is arranged such that the unit 10 can communicate in a wireless manner with the computer 16. This can take place through radio communication, for example according to the bluetooth standard. The switching member 20 is thus in this case arranged to influence the transmitter member 26 such that the transmitter member 26 transmits a control signal to a receiver member 28 which is connected to the computer 16 or which is arranged in the computer 16. The control signal thus gives the computer 16 information whether the switching member 20 is in the first or in the second switching state. In the same manner as has been described above, the computer 16 is arranged such that the unit 10 is connected for use (for example for conversational communication via the computer) when the switching member 20 is in the first switching state. In the first switching state, the loudspeaker 18 is not active.

If a separate microphone 36 is connected to the computer 16, the corresponding is the case concerning this microphone 36 when the switching member 20 is in the first and the second switching state, respectively. In the first switching state, the microphone part 12 is thus active while the separate microphone 36 is not active. In the second switching state, the microphone part 12 is not active while the microphone 36 is active.

As will be described below, the switching member 20 is arranged to be switched by moving first 61 and second 62 end portions of the headset 11.

FIG. 4 shows schematically a circuit diagram when the unit 10 is in the first switching state. Different parts which have been described above are schematically marked in FIG. 4 and the same reference numbers are used. From the loudspeaker 18 the cable 24 thus extends. In FIG. 4 is shown that the cable contains two leads. The cable 24 ends with the contact 42 which is connected to the second contact member 32 of the unit 10. The leads from the loudspeaker 18 are via the cable 22 connected to the switching member 20. The switching member 20 is connected to the ear-headphone part 14. The unit 10 is also via the first contact member 31 connected to the loudspeaker input terminal 41 of the computer 16. In a corresponding manner, the cable 38 extends from the microphone 36. The cable 38 ends with the contact 44 which is connected to the fourth contact member 34. The leads lead to the switching member 20 which is connected to the microphone part 12. The cable 22 is also connected to the microphone input terminal 43 of the computer 16 via the third contact member 33. For the sake of clarity, in FIG. 4 the leads for the microphone part 12 have been separated from the leads for the ear-headphone part 14. The switching member 20 is shown schematically. As can be seen in FIG. 4, the switching member 20 is set such that the microphone part 12 and the ear-headphone part 14 are connected to the computer 16 while the loudspeaker 18 and the microphone 36 are not connected to the computer 16.

FIG. 5 shows schematically the same circuit diagram as FIG. 4 but when the switching member 20 is in the second switching state. As can be seen from the lead arrangement in FIG. 5, the loudspeaker 18 and the microphone 36 are connected to the computer 16 while the microphone part 12 and the ear-headphone part 14 are not connected to the computer 16.

It should be noted that the circuit diagram is only a schematic example of how the switching member 20 can be designed. Alternative lead arrangements are however obvious to a person skilled in the art. Furthermore, as has been mentioned above, the loudspeaker 18 and/or the microphone 36 can also be arranged for stereo sound. In this case, there are further leads in the respective cables.

In case the unit 10 is connected in a wireless manner to the computer 16, suitable control signals are sent which control the connection and disconnection of loudspeaker 18, microphone 36, microphone part 12 and ear-headphone part 14 in a corresponding manner as in the example according to FIG. 4 and 5.

FIGS. 6-9 show schematically different embodiments of the headset 11 comprised in the unit 10 according to the invention. For the sake of simplicity, the microphone part 12, that may form part of the headset 11, is not shown in these figures. FIG. 6 shows that the headset 11 has a curved flexible support member 50, which comprises a first part 51 and a second part 52. These parts 51, 52 are pivotally connected to each other in a connection area 56 (indicated by hatched lines in FIGS. 6-9). The pivotal connection can for example be formed with the help of hinge means 58. The support member 50 is configured to be able to extend around a part of a user's head in order to hold the headset 11 onto the head. The first part 51 of the support member 50 includes a first end portion 61. The second part 52 of the support member 50 includes a second end portion 62.

The ear-headphone part 14 can comprise one or two ear-headphones (speakers). In the embodiment of FIG. 6, 7 and 9, a first ear-headphone is located at the first end portions 61 and a second ear-headphone is located at the second end portion 62. FIG. 8 shows an alternative embodiment where the headset 11 only has one ear-headphone.

Due to the construction of the headset 11, the first end portion 61 and the second end portion 62 can be moved closer to each other (for example as shown in FIG. 9) or further away from each other (for example as shown in FIG. 6, 7 and 8). The above described switching member 20 can suitable be arranged somewhere in the headset 11, for example at one or both of the ear-headphones or in the support member 50. In order to switch the switching member 20 between the above-described first and second states, the headset 11 comprises switching activating means 54. These switching activating means 54 can for example constitute a switch arranged in the connection area 56. The switching activating means 54 is of course connected to or forms part of the switching member 20 in order to initiate the first and second switching states. The switching activating means 54 can be formed for example by some kind of toggle switch, for example including a spring-loaded arm designed such that the mentioned first switching state is initiated when the first 61 and second 62 end portions are moved away from each other to the position shown in for example FIG. 6. The second switching state can be initiated by the switching activating means 54 when the first 61 and second 62 end portions are in a position closer to each other (as shown in FIG. 9). Alternatively, it is possible that the switching activating means 54 are designed such that the first switching state is initiated every second time the first 61 and second 62 end portions are moved away from each other (to the position shown in FIG. 6, or further apart), while every other second time the first 61 and second 62 end portions are moved away from each other, the second switching state is initiated.

FIG. 7 shows a somewhat different embodiment where the first part 51 of the support member 50 partly overlaps the second part 52 of the support member 50. The first part 51 is attached to the second part 52 at some hinge means 58. In this case, the switching activating means 54 can for example be formed by some push-button switch arranged in the area where the first part 51 overlaps with the second part 52. The switching activating means 54 can of course be formed in different other manners as those described, as long as a switching state is initiated by moving the first 61 and second 62 end portions as described above. The switching activating means 54 can comprise a mechanical switch or a non-mechanical switch, for example a capacitive or inductive switch.

The invention also concerns a computer system. This computer system comprises the unit 10 together with the computer 16 and at least one loudspeaker 18. This loudspeaker 18 can be a desk or floor loudspeaker 18 or a loudspeaker which is built-in in the computer 16. Also a microphone 36 may form part of the computer system.

The invention is not limited to the described embodiments but can be varied and modified within the scope of the annexed claims.

1-13. (canceled)

14. An ear-headphone unit comprising a headset having a curved flexible support member which is configured to be able to extend around a part of a user's head in order to hold the headset onto said head, the support member comprising a first and a second end portion which can be moved in a direction away from each other before the headset is attached to the head of the user, the headset comprising an ear-headphone part which is arranged on the headset such that when the headset is attached as intended to a user's head, the ear-headphone part is arranged at at least one ear of the user, wherein said unit is arranged to be able to be connected to a computer such that sounds can be produced by said ear-headphone part with the help of the computer, wherein the computer is of the kind which at least also can be connected to a loudspeaker, which can be a desk or floor loudspeaker, or which has a built-in loudspeaker, said unit further comprising a switching member with at least a first and a second switching state, wherein the unit is arranged such that, when the unit is connected as intended to said computer and the switching member is in said first switching state, the unit is connected for use such that said ear-headphone part is active while said desk or floor loudspeaker or built-in loudspeaker is not active, wherein in said second switching state at least said ear-headphone part is not active while said desk or floor loudspeaker or built-in loudspeaker is active and wherein said headset comprises switching activating means which are such that said first switching state is initiated by moving said first and second end portions away from each other.

15. A unit according to claim 14, wherein said support member comprises a first part, which includes said first end portion, and a second part, which includes said second end portion, wherein said first and second parts are pivotally connected to each other in a connection area, wherein said switching activating means is located in said connection area and arranged such that when the first and second end portions are moved away from each other, a relative pivotal movement takes place between said first and second parts, wherein said relative pivotal movement causes the switching activating means to initiate said first switching state.

16. A unit according to claim 14, comprising a transmitter member arranged such that the unit can communicate in a wireless manner with said computer, wherein the transmitter member is arranged such that when said switching member is in or is being switched to said first switching state, the transmitter member transmits a control signal to a corresponding receiver member connected to the computer, such that the control signal ensures that when the switching member is in the first switching state, the computer is arranged such that the unit is connected for use together with the computer while said desk or floor loudspeaker or built-in loudspeaker is not active.

17. A unit according to claim 14, comprising a cable which on one hand is connected to or arranged to be connected to at least said ear-headphone part and on the other hand is arranged to be connected at least to said computer.

18. A unit according to claim 17, wherein said cable is provided with at least a first contact member and a second contact member, wherein the first contact member is arranged to be connected to the computer and the second contact member is arranged to, for example via a further cable, be connected to said desk or floor loudspeaker.

19. A unit according to claim 18, wherein said first contact member is a male contact of standard type which is configured to be plugged into a corresponding female contact which constitutes the loudspeaker input terminal of the computer, wherein said second contact member is a female contact of standard type which is configured to receive a corresponding male contact on a cable from said desk or floor loudspeaker.

20. A unit according to claim 14, wherein the headset also comprises a microphone part which is arranged on the headset such that when the headset is attached as intended to a user's head, the microphone part is arranged near the user's mouth.

21. A unit according to claim 20, arranged such that when the unit is connected to said computer and the switching member is in said first switching state, said microphone part is active while a possible built-in microphone of the computer or a separate microphone, with which the computer is connected, is not active, wherein when the switching member is in said second switching state, said microphone part is not active while said possible built-in microphone of the computer or said separate microphone, with which the computer is connected, is active.

22. A unit according to claim 20, wherein said cable is also connected to or arranged to be connected to said microphone part.

23. A unit according to claim 22, wherein said cable is provided also with a third contact member and a fourth contact member, wherein the third contact member is arranged to be connected to the computer and the fourth contact member is arranged to, for example via a further cable, be connected to said separate microphone.

24. A unit according to claim 23, wherein said third contact member is a male contact of standard type which is configured to be plugged into a corresponding female contact which constitutes the microphone input terminal of the computer and wherein said fourth contact member is a female contact of standard type which is configured to receive a corresponding male contact on a cable from said separate microphone.

25. A unit according to claim 20, wherein said unit is connectable to said computer in order to with the help of the unit enable conversational communication via a network for computers, for example the Internet, wherein the unit is arranged such that, when the unit is connected as intended to said computer and the switching member is in said first switching state, the unit is connected for use for conversational communication via the computer such that said microphone part and said ear-headphone part are active while said desk or floor loudspeaker or built-in loudspeaker is not active, wherein in said second switching state at least said ear-headphone part is not active while said desk or floor loudspeaker or built-in loudspeaker is active.

26. A computer system comprising a unit according to claim 14, said computer with at least one loudspeaker which can be a desk or floor loudspeaker or which can be built-in in the computer.
